(19) United States
(12) Patent Application Publication
(10) Pub. No.: US 2025/0358378 A1
(43) Pub. Date: Nov. 20, 2025

(54) IMAGE READING APPARATUS AND IMAGE FORMING APPARATUS

(71) Applicant: CANON KABUSHIKI KAISHA, Tokyo (JP)

(72) Inventors: AKIRA URITA, Ibaraki (JP); YUTA MORIYA, Kanagawa (JP); KOUGA OKADA, Tokyo (JP); NARUMASA ITO, Tochigi (JP)

(21) Appl. No.: 19/090,212

(22) Filed: Mar. 25, 2025

(30) Foreign Application Priority Data
May 14, 2024 (JP) 2024-078953

(51) Int. Cl. H04N 1/028; G03G 15/22; H04N 1/00

(52) U.S. Cl. CPC H04N 1/02835; G03G 15/228; H04N 1/00795; H04N 2201/0094

(57) ABSTRACT

An image reading apparatus includes a light guide unit provided with a light guide member, a reading portion, and a supporting member including a supporting portion to support the light guide unit, first and second opposing portions opposing first and second ends of the light guide member in a longitudinal direction, respectively. One of the first end and the first opposing portion includes a first projection projecting in the longitudinal direction, and the other includes a first concave portion of which a width is wider than that of the first projection and into which the first projection is inserted with a gap. One of the second end and the second opposing portion includes a second projection, and the other includes a second concave portion of which width is wider than that of the second projection and into which the second projection is inserted with a gap.

### FIELD OF THE INVENTION AND RELATED ART

The present invention relates to an image reading apparatus in which a light guide member is supported by a supporting member and an image forming apparatus.

In general, to an image reading apparatus provided to an image forming apparatus, etc., an illuminating device, in which a plurality of LEDs are arranged in a straight line to illuminate light on an original upon reading an original image, is provided. In a case in which the plurality of the LEDs are used as a light source, in order to suppress an occurrence of unevenness in illuminance distribution in an arranging direction of the LEDs on an original surface, between the original surface and the LEDs, a transparent light guide member made of resin, etc. is provided to the illuminating device. This light guide member guides a light, which is emitted from the plurality of LEDs and diffused in a circular shape, toward the original surface along a main scanning direction (the arranging direction of the LEDs) during original reading.

By the way, if there are variations in positions and/or postures of the LEDs and of the light guide member, an illuminating position on the original surface may be fluctuated from a designed position, and blurring of a read image due to an insufficient light amount and/or blurring of the read image due to fluctuation in an optical passage length may occur. For this reason, it has been proposed that a configuration which enables positioning between the light guide member and a supporting member with high accuracy by making contacting surfaces, which are provided to both end portions in a longitudinal direction of the light guide member, respectively, contact and adhere to contacting surfaces of the supporting member (see Japanese Patent Application Laid-Open No. 2019-149778).

Such light guide member may be bent, after being attached to the supporting member, in a direction perpendicular to the longitudinal direction (so-called warpage may occur). In such a case, there is a problem that the adhesive portions between the light guide member and the supporting member are peeled off, and positional misalignment of the light guide member with respect to the supporting member occurs. As a result, the light guide member is positioned out of the designed position relative to the supporting member as described above, and the illuminating light amount may be insufficient relative to a designed value, leading to degradation of a read image.

### SUMMARY OF THE INVENTION

Thus, an object of the present invention is to provide an image reading device and an image forming apparatus which are capable of reducing positional misalignment between a light guide member and a supporting member.

An aspect of the present invention is an image reading apparatus comprising: a light guide unit provided with a substrate including a plurality of light sources arranged side by side in a longitudinal direction and a light guide member configured to guide a light emitted from the light sources to an original; a reading portion configured to read an image of the original which reflects the light irradiated from the light sources through the light guide member; and a supporting member including a supporting portion configured to support the light guide unit by the light guide unit being adhered to the supporting member, a first opposing portion opposing a first end portion of the light guide member in the longitudinal direction, and a second opposing portion opposing a second end portion, opposite to the first end portion, of the light guide member in the longitudinal direction, wherein one of the first end portion and the first opposing portion includes a first projection projecting in the longitudinal direction, wherein the other of the first end portion and the first opposing portion includes a first concave portion which has a concave shape having a wider width than that of the first projection and into which the first projection is inserted with a gap, wherein one of the second end portion and the second opposing portion includes a second projection projecting in the longitudinal direction, and wherein the other of the second end portion and the second opposing portion includes a second concave portion which has a concave shape having a wider width than that of the second projection and into which the second projection is inserted with a gap.

Further features of the present invention will become apparent from the following description of exemplary embodiments with reference to the attached drawings.

### BRIEF DESCRIPTION OF THE DRAWINGS

FIG. 1 is a schematic cross-sectional view illustrating an image forming apparatus according to an Embodiment 1.

FIG. 2 is a perspective view illustrating an outer appearance of an image reading apparatus according to the Embodiment 1.

FIG. 3 is a schematic cross-sectional view illustrating the image reading apparatus according to the Embodiment 1.

FIG. 4 is a perspective view illustrating an outer appearance of a reading unit according to the Embodiment 1.

FIG. 5 is a schematic cross-sectional view of a front surface reading portion according to the Embodiment 1.

FIG. 6 is a perspective view illustrating an outer appearance of an illuminating unit according to the Embodiment 1.

Part (a) of FIG. 7 is an exploded perspective view of a light guide unit according to the Embodiment 1. Part (b) of FIG. 7 is a perspective view illustrating a back surface of a light guide according to the Embodiment 1. Part (c) of FIG. 7 is an enlarged perspective view illustrating a back surface of an end portion of the light guide according to the Embodiment 1.

Part (a) of FIG. 8 is a top view illustrating a light guide stay according to the Embodiment 1. Part (b) of FIG. 8 is an enlarged perspective view illustrating an end portion of the light guide stay according to the Embodiment 1.

Part (a) of FIG. 9 is a top view illustrating an end portion of the illuminating unit according to the Embodiment 1. Part (b) of FIG. 9 is a side view illustrating the illuminating unit according to the Embodiment 1.

FIG. 10 is an explanatory view illustrating a warping direction of the light guide according to the Embodiment 1.

Part (a) of FIG. 11 is a top view illustrating an end portion of an illuminating unit according to an Embodiment 2. Part (b) of FIG. 11 is a side view illustrating the illuminating unit according to the Embodiment 2.

FIG. 12 is a top view illustrating an end portion of an illuminating unit according to an Embodiment 3.

### DESCRIPTION OF THE EMBODIMENTS

### Embodiment 1

Hereinafter, an Embodiment 1 will be described using the drawings.

### [Outline Configuration of an Image Forming Apparatus]

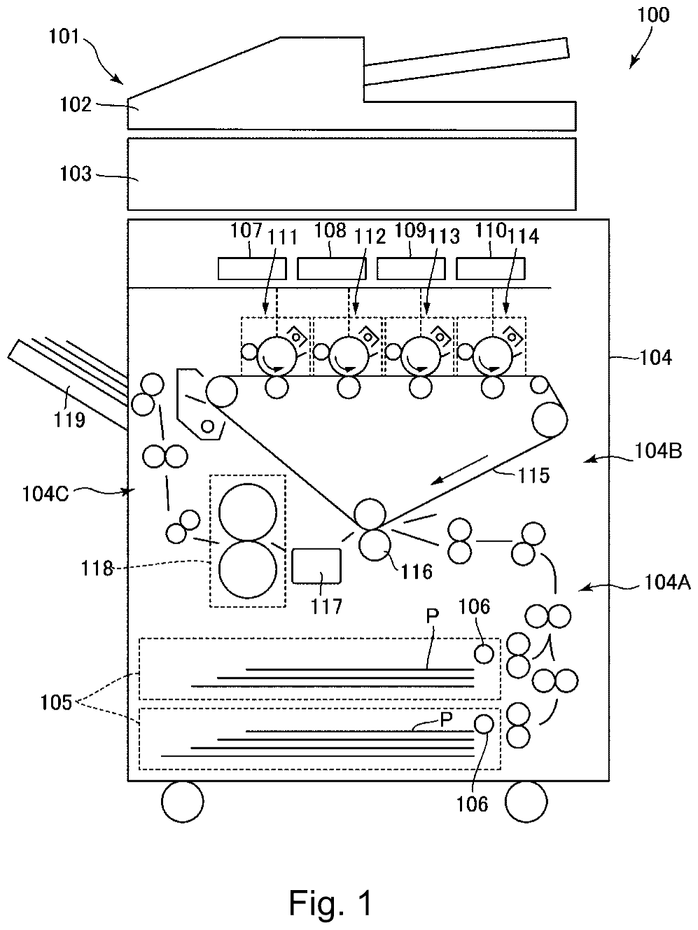

First, an outline configuration of an image forming apparatus 100 according to the Embodiment 1 will be described using FIG. 1. FIG. 1 is a schematic cross-sectional view illustrating the image forming apparatus 100 according to the Embodiment 1.

As shown in FIG. 1, the image forming apparatus 100 is provided with an image reading apparatus 101 capable of reading an image of an original, and an image forming apparatus main assembly 104 capable of forming the image read by the image reading apparatus 101 onto a sheet P. In addition, the image reading apparatus 101, which will be described in detail below, is provided with a reading unit 103, which reads the image of the original, and an automatic document feeder (hereinafter, referred to as an “ADF”) 102, which can automatically feed the original to the reading unit 103, and is disposed above the image forming apparatus main assembly 104. Incidentally, the image forming apparatus 100 shown in FIG. 1 is a laser beam printer of electrophotographic type, however, the image reading apparatus 101 in the present Embodiment may also be applied similarly to an image forming apparatus using an inkjet type or other image forming methods as an image forming means.

The image forming apparatus main assembly 104 is provided with, roughly speaking, a feeding portion 104A which feeds the sheet P, an image forming portion 104B which forms an image on the sheet P fed by the feeding portion 104A, and a discharging portion 104C which discharges the sheet P on which the image has been formed by the image forming portion 104B.

The feeding portion 104A is constituted by cassettes 105 and 105 which support and accommodate a plurality of the sheets P, and feeding rollers 106 and 106 which pick up and start feeding the sheet P from the cassettes 105 and 105. The sheet P fed by the feeding roller 106 is fed toward a secondary transfer roller 116 in the image forming portion 104B.

The image forming portion 104B is constituted by laser scanners 107, 108, 109 and 110, image forming units 111, 112, 113 and 114, an intermediary transfer belt 115, the secondary transfer roller 116, a pre fixing conveyance portion 117 and a fixing portion 118. The image forming unit 111 develops an electrostatic latent image exposed by the laser scanner 107 as a yellow (Y) toner image, and primarily transfers the toner image to the intermediary transfer belt 115. In addition, similarly, the image forming unit 112 develops the electrostatic latent image exposed by the laser scanner 108 as a magenta (M) toner image, and primarily transfers the toner image to the intermediary transfer belt 115. Furthermore, similarly, the image forming unit 113 develops the electrostatic latent image exposed by the laser scanner 109 as a cyan (C) toner image, and primarily transfers the toner image to the intermediary transfer belt 115. And similarly, the image forming unit 114 develops the electrostatic latent image exposed by the laser scanner 110 as a black (K) toner image, and primarily transfers the toner image to the intermediary transfer belt 115. By this, on a surface of the intermediary transfer belt 115, a full-color toner image is formed.

The full-color toner image transferred to the surface of the intermediary transfer belt 115 is conveyed to the secondary transfer roller 116, and is secondarily transferred to a surface of the sheet P, which is fed by the feeding portion 104A, by the secondary transfer roller 116. The sheet P on which the toner image has been transferred is conveyed to the fixing portion 118 by the pre fixing conveyance portion 117, which conveys the sheet by an unshown conveyance belt, etc. And by the sheet P being heated (and pressed) in the fixing portion 118, the toner image is fixed to the sheet P. Thereafter, the sheet P to which the toner image has been fixed is conveyed by the discharging portion 104C and discharged so as to be stacked on a discharge tray 119.

Incidentally, the configuration of the image forming apparatus main assembly 104 described above is an example, and may be changed in various ways. For example, to enable a double-side printing, the apparatus may be provided with a reversing portion, which reverses a front and a back of the sheet, a reconveyance path, which conveys the sheet again to the secondary transfer roller 116, etc. In addition, it may also be a configuration which directly transfers the toner image from the image forming unit to the sheet, or a configuration which performs a monochrome image formation. Furthermore, it may be a configuration provided with a manual feed tray to which the sheet is manually fed.

### [Configuration of the Image Reading Apparatus]

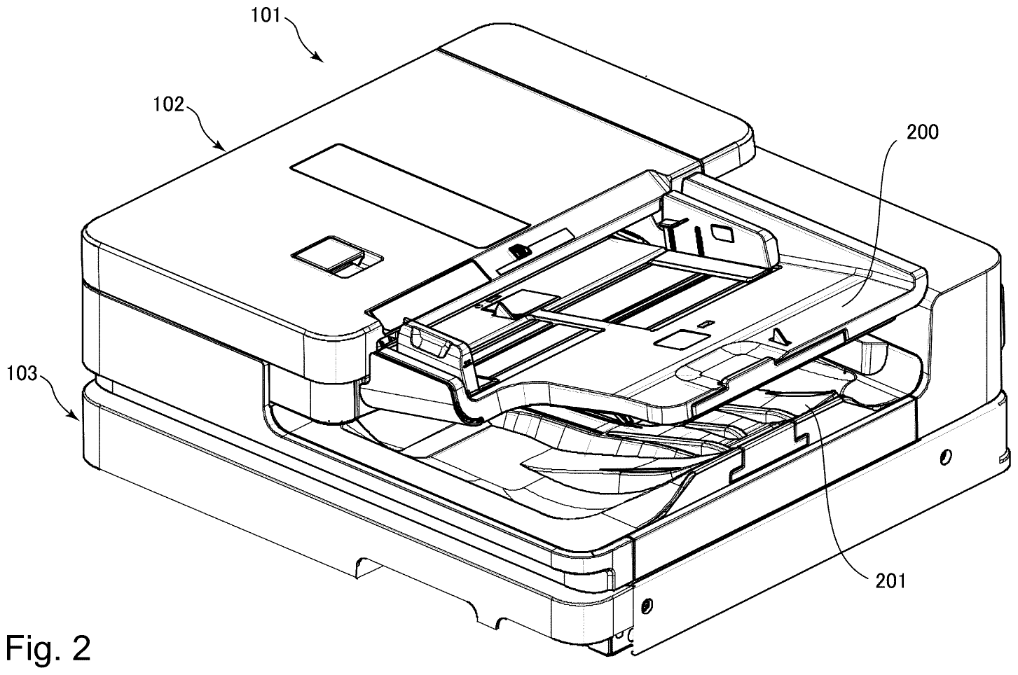

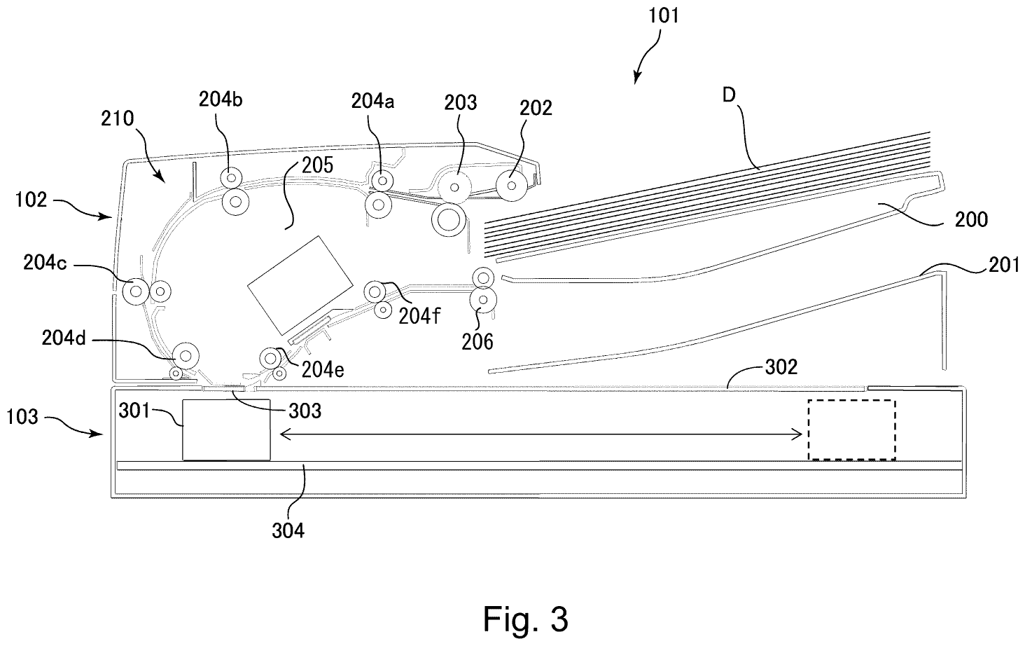

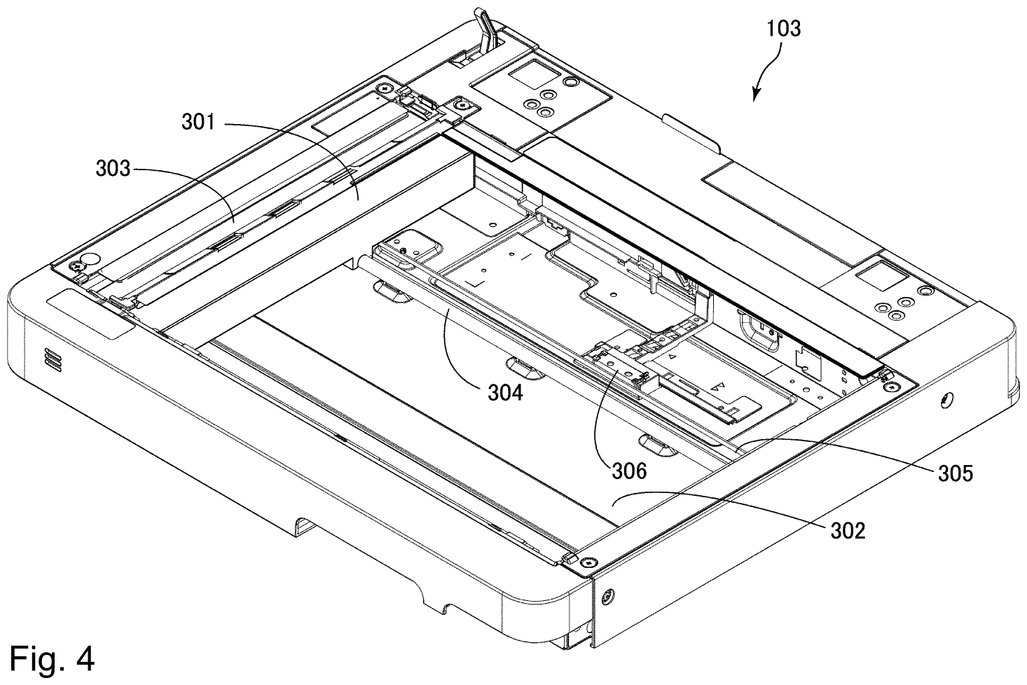

Next, a configuration of the image reading apparatus 101 according to the Embodiment 1 will be described using FIGS. 2, FIG. 3 and FIG. 4. FIG. 2 is a perspective view illustrating an outer appearance of the image reading apparatus according to the Embodiment 1. FIG. 3 is a schematic cross-sectional view illustrating the image reading apparatus according to the Embodiment 1. FIG. 4 is a perspective view illustrating an outer appearance of a reading unit according to the Embodiment 1.

As shown in FIG. 2 and FIG. 3 and as described above, the image reading apparatus 101 includes the reading unit 103 and the ADF 102. As shown in FIG. 3, the ADF 102 includes an original tray 200 on which originals D are placed, a discharge tray 201 on which the originals D of which an image has been read are discharged and stacked, and an original conveyance portion 210 which conveys the original D from the original tray 200 to the discharge tray 201. The original conveyance portion 210 includes a pickup roller 202 which contacts the uppermost originals D on the original tray 200 and starts feeding of the originals D, and a separating roller pair 203 which separates and conveys the originals D fed by the pickup roller 202 one by one. Furthermore, the original conveyance portion 210 includes a plurality of conveyance roller pairs 204a, 204b, 204c, 204d, 204e and 204f, which convey the original D conveyed from the separating roller pair 203, and a discharging roller pair 206 which discharges the original D to the discharge tray 201. Among these conveyance roller pairs, between the conveyance roller pair 204d and the conveyance roller pair 204e in a conveyance direction of the original D, a skimming through glass 303 which permits reading of a front surface of the original D, which will be described in detail below, is disposed. In addition, between the conveyance roller pair 204e and the conveyance roller pair 204f, a back surface reading portion 205, which reads a back surface of the original D, is disposed.

On the other hand, the reading unit 103 includes, as shown in FIG. 3 and FIG. 4, on an upper surface thereof, the skimming through glass 303 and an original supporting platen glass 302, and below thereof, is provided with a front surface reading portion 301 as a reading portion for reading the front surface of the original D. The front surface reading portion 301 is supported movably in a sub scanning direction of the front surface reading portion 301 by a guide shaft 304, and is configured to be capable of being controlled in moving in the sub scanning direction by a belt 305, which is driven by an unshown driving motor. Incidentally, below the original supporting platen glass 302, an original detecting sensor 306 (FIG. 4), which detects the original D when the original D is placed thereon, is disposed.

The image reading apparatus 101 configured as described above is capable of selectively executing a fixed reading mode, in which the image of the original placed on the original supporting platen glass 302 is scanned and read, and a skimming through mode, in which the image of the original is scanned and read while the original D is fed by the ADF 102.

The skimming through mode is selected, for example, in a case in which the unshown sensor detects that the original D is placed on the original tray 200 of the ADF 102, or in a case in which the user explicitly instructs the skimming through mode through an unshown operating panel, etc. provided to the image forming apparatus 100. In a case of the present mode, the front surface reading portion 301 is set in a state of being moved along the guide shaft 304 to a predetermined image reading position below the skimming through glass 303. And the ADF 102 conveys the originals D placed on the original tray 200 so as to pass through the skimming through glass 303 one by one to read an image of the front surface thereof, and furthermore, conveys the original D so as to pass through the back surface reading portion 205 to read an image of the back surface thereof.

In detail, as shown in FIG. 3, in a state in which one or several sheets of the original D are placed on the original tray 200 by a user, the skimming through mode is executed. Then, for the originals D placed on the original tray 200, the feeding of the uppermost originals D is started by the pickup roller 202, and if the originals D are overlappingly fed, then the originals D are separated one by one by the separating roller pair 203. Then, by the conveyance roller pairs 204a, 204b, 204c and 204d, the original D is conveyed to the reading position for the front surface reading portion 301, and the image reading of the front surface of the original D is performed. Furthermore, the original D is conveyed by the conveyance roller pair 204e to a reading position for the back surface reading portion 205, and the image reading of the back surface of the original D is performed. And the original D, whose image has been read, is conveyed by the conveyance roller pair 204f to the discharging roller pair 206, and is discharged to the discharge tray 201 by the discharging roller pair 206.

The fixed reading mode is selected, for example, in a case in which the original detecting sensor 306 detects that the original D is placed on the original supporting platen glass 302, or in a case in which the user explicitly instructs the fixed reading mode through the unshown operating panel, etc. of the image forming apparatus 100.

In the fixed reading mode, first, the user opens the ADF 102, which is openably and closably provided to the reading unit 103, places the original D on the original supporting platen glass 302 at a predetermined position, and positions the original D with respect to the original supporting platen glass 302 by closing the ADF 102. At this time, the above original detecting sensor 306 detects presence or absence and a size of the original D. Then, while the front surface reading portion 301 is moved in the sub scanning direction along the original supporting platen glass 302 by the unshown driving motor, the front surface reading portion 301, while irradiating a light, scans the original D placed on the original supporting platen glass 302 in a main scanning direction to read the image of the original D.

Incidentally, in the present Embodiment, it is described as the configuration is provided with the back surface reading portion 205, however, it is not necessarily limited to the configuration which is provided with the back surface reading portion 205. In addition, as another Embodiment, in the reading unit 103, a reading portion for performing the skimming through mode and a reading portion for performing the fixed reading mode may be separately provided thereto.

### [Configuration of the Front Surface Reading Portion]

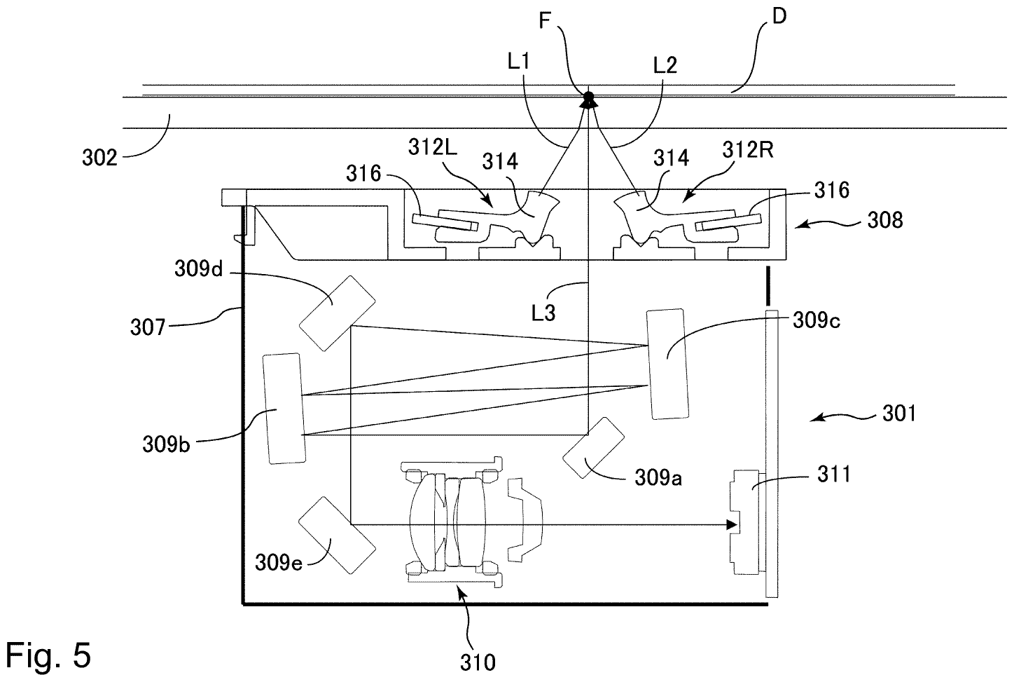

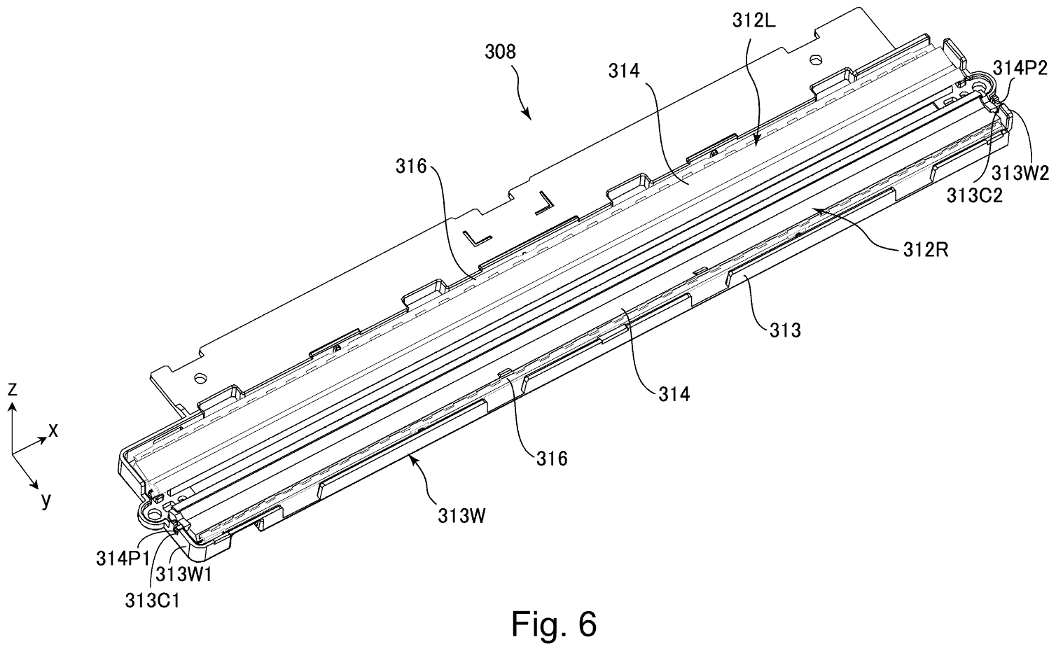

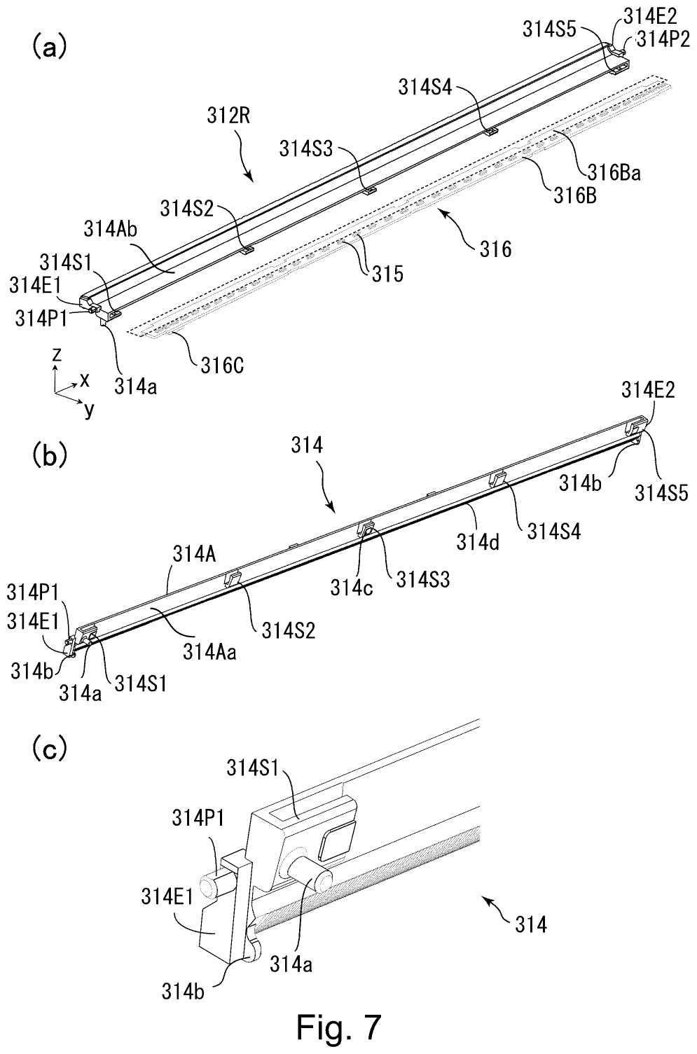

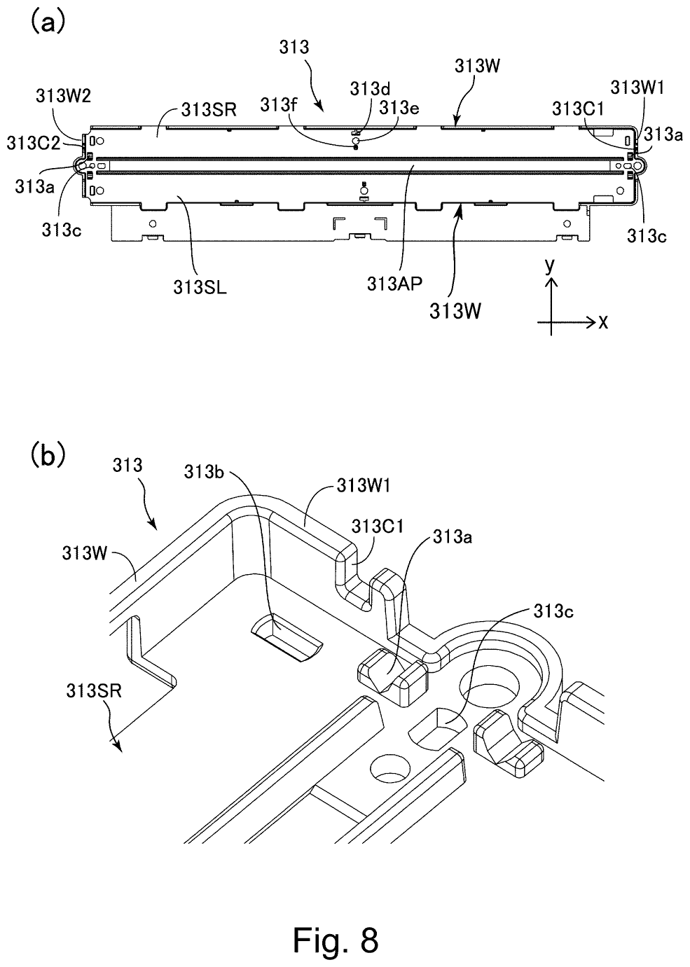

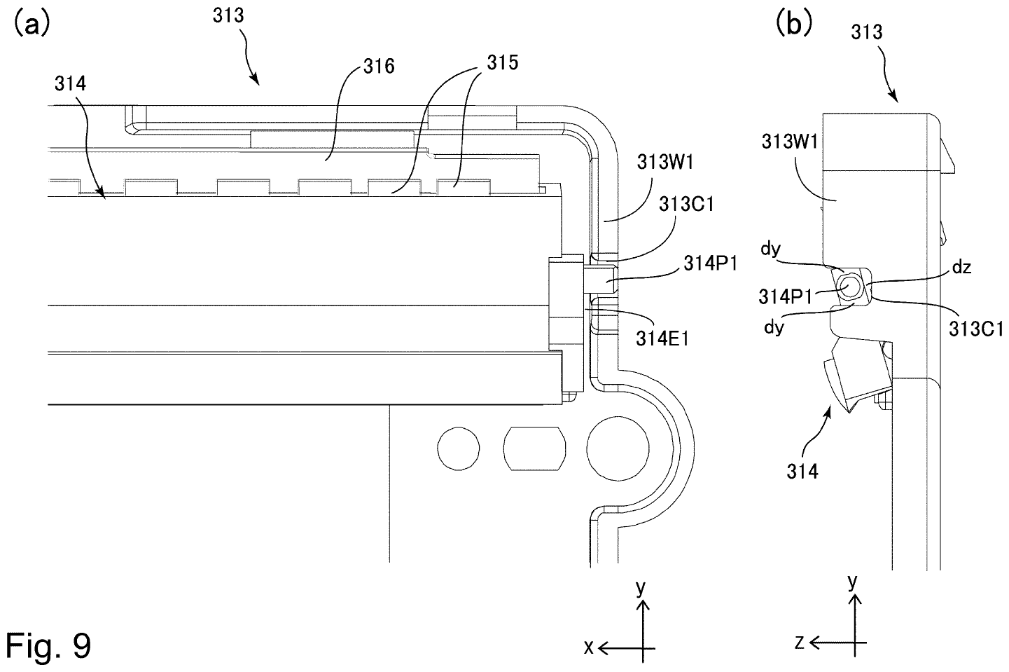

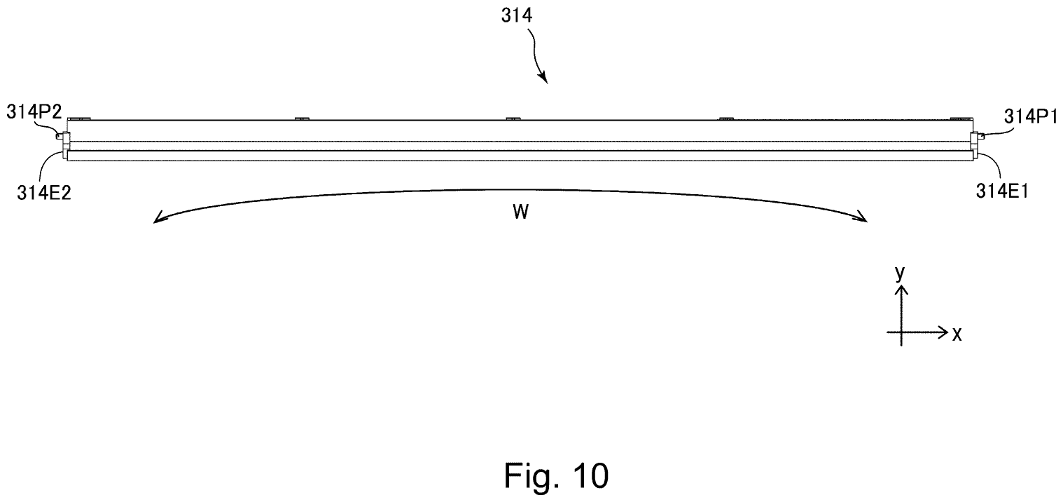

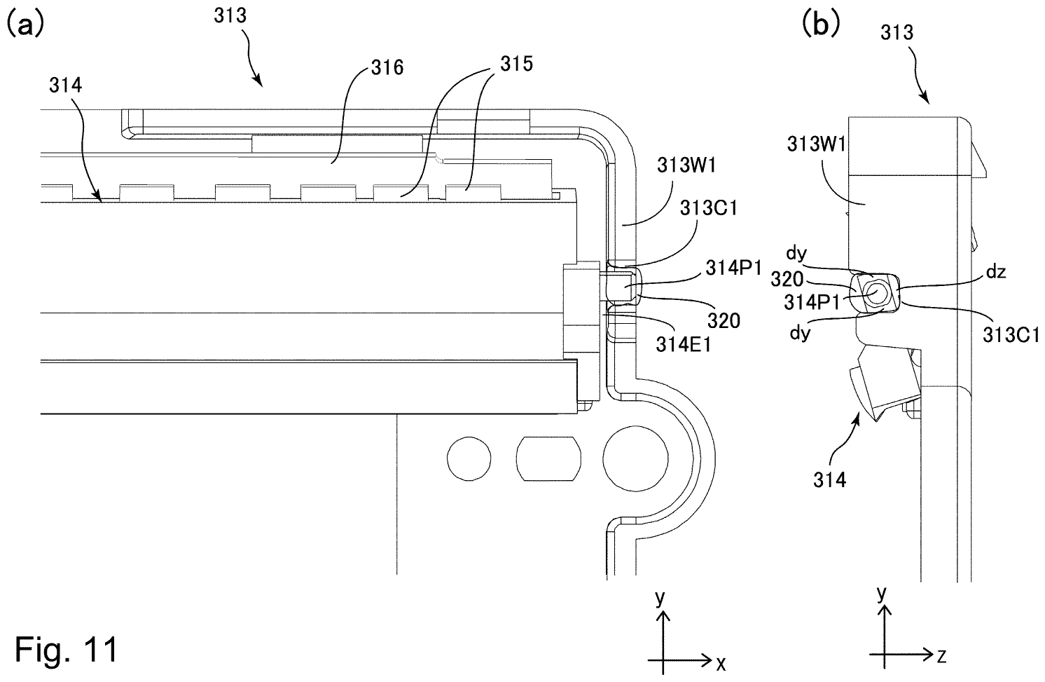

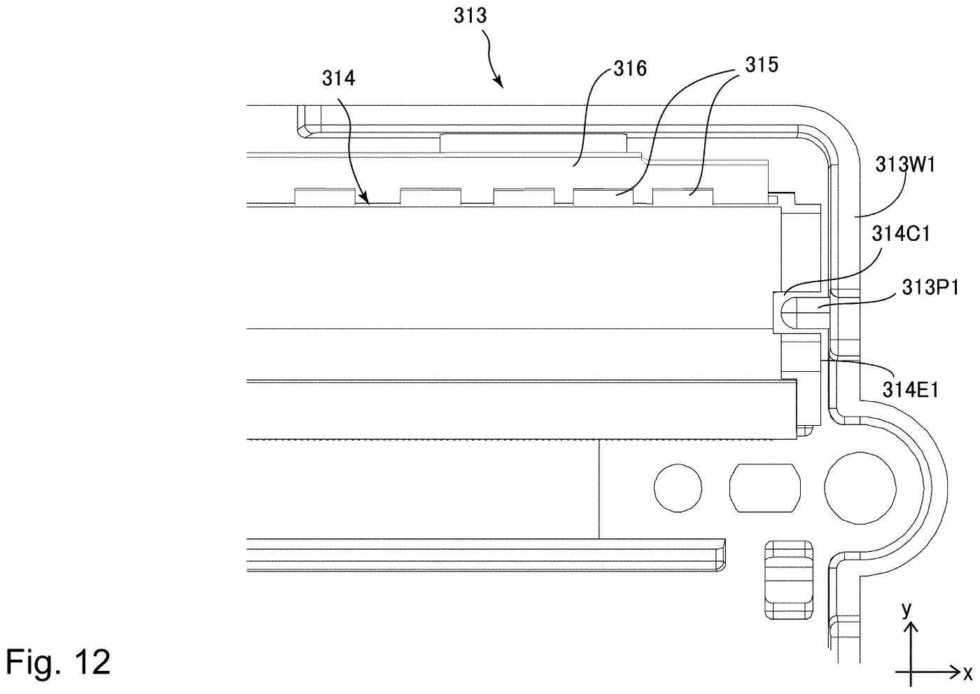

Next, a configuration of the front surface reading portion 301 will be described using FIG. 5, FIG. 6, FIG. 7, FIG. 8 and FIG. 9. FIG. 5 is a schematic cross-sectional view of the front surface reading portion according to the Embodiment 1. FIG. 6 is a perspective view illustrating an outer appearance of an illuminating unit according to the Embodiment 1. Part (a) of FIG. 7 is an exploded perspective view of a light guide unit according to the Embodiment 1. Part (b) of FIG. 7 is a perspective view illustrating a back surface of a light guide according to the Embodiment 1. Part (c) of FIG. 7 is an enlarged perspective view illustrating a back surface of an end portion of the light guide according to the Embodiment 1. Part (a) of FIG. 8 is a top view illustrating a light guide stay according to the Embodiment 1. Part (b) of FIG. 8 is an enlarged perspective view illustrating an end portion of the light guide stay according to the Embodiment 1. Part (a) of FIG. 9 is a top view illustrating an end portion of the illuminating unit according to the Embodiment 1. Part (b) of FIG. 9 is a side view illustrating the illuminating unit according to the Embodiment 1.

As shown in FIG. 5, the front surface reading portion 301 includes a box frame 307 and an illuminating unit 308 attached to an upper portion in the box frame 307. In addition, the front surface reading portion 301 includes, in the box frame 307 and below the illuminating unit 308, reflecting mirrors 309a, 309b, 309c, 309d and 309e, a lens unit 310, and a sensor substrate 311 as a reading portion.

The illuminating unit 308 includes light guide units 312L and 312R as two light guide units. Lights L1 and L2 emitted from these light guide units 312L and 312R toward the original D, respectively, is condensed to an illuminating position F, which is set on the front surface (lower surface) of the original D, and is reflected by the original D. A reflected light L3 reflected by the original D forms an image on an unshown sensor element on the sensor substrate 311 via the mirrors 309a, 309b, 309c, 309d and 309e and the lens unit 310. The sensor substrate 311 applies photoelectric conversion to the image formed on the sensor element by the reflected light L3, and outputs an electric signal corresponding to the image of the front surface of the original D to an unshown control portion.

As shown in FIG. 6, the illuminating unit 308 is provided with a light guide stay 313 as a supporting member to which the light guide units 312L or 312R is attached. The light guide units 312L and 312R have the same configuration and are disposed symmetrically in the sub scanning direction. Incidentally, since the configurations of the light guide units 312L and 312R and attaching methods thereof to the light guide stay 313 are the same, hereinafter, the light guide unit 312R will be described as an example, and description for the light guide unit 312L will be omitted.

As shown in FIG. 5, FIG. 6 and part (a) of FIG. 7, the light guide unit 312R is constituted by a light guide 314 as a light guide member and an LED substrate 316 as a substrate provided with the plurality of LEDs 315 as light sources. As shown in part (a) of FIG. 7, to the light guide 314, a plurality of (five) slot portions 314S1, 314S2, 314S3, 314S4 and 314S5 which support the LED substrate 316 are provided. The LED substrate 316 is provided with a substrate portion 316B, the LEDs 315 as a plurality of the light sources mounted on the substrate portion 316B, and a connector portion 316C which is electrically connected to the plurality of LEDs 315. The plurality of LEDs 315 are mounted in a straight line in a longitudinal direction (x direction) on the substrate portion 316B, and electric power is supplied thereto via the connector portion 316C by an unshown electric wiring. A region in a broken line shown in part (a) of FIG. 7 is an inserting portion 316Ba included in the substrate portion 316B, and the inserting portion 316Ba is inserted into the slot portions 314S1, 314S2, 314S3, 314S4 and 314S5 of the light guide 314. By this, the LED substrate 316 is assembled to the light guide 314. Incidentally, in the description below, the main scanning direction of the front surface reading portion 301 or the longitudinal direction of the light guide 314 is also referred to as the x direction. In addition, the sub scanning direction, which is the moving direction of the front surface reading portion, or a widthwise direction of the light guide 314 is also referred to as a y direction. And a vertical direction perpendicular to these x direction and y direction is also referred to as a z direction.

The light guide 314 includes, as shown in part (a) of FIG. 7 and part (b) of FIG. 7, a flat plate portion 314A having a flat plate shape. A lower surface of the flat plate portion 314A serves as an incident surface 314Aa on which the lights irradiated from the plurality of LEDs 315 are incident, and an upper surface of the flat plate portion 314A serves as an emergent surface 314Ab from which the incident lights are emitted toward the irradiating position F (see FIG. 3) of the original D. The lights of the plurality of LEDs 315 incident from the incident surface 314Aa are, after reflected several times in the flat plate portion 314A, guided by the emergent surface 314Ab and emitted.

In addition, the light guide 314 also includes a first end portion 314E1 and a second end portion 314E2, which are both end portions in the x direction, which is the longitudinal direction. That is, the light guide 314 includes the first end portion 314E1 at one end portion in the x direction and the second end portion 314E2 on an opposite side to the first end portion 314E1. The light guide 314 includes, as shown in part (b) of FIG. 7, contacting surfaces 314b and 314b as a first contacting surface and a second contacting surface below in the z direction of the first end portion 314E1 and the second end portion 314E2. These contacting surfaces 314b and 314b are formed in an arc shape as viewed from the x direction and contact supporting surfaces 313a and 313a (see part (b) of FIG. 8) as a first supporting surface and a second supporting surface of the light guide stay 313, which will be described in detail below. In addition, the light guide 314 includes an opposite surface 314c, which is disposed below in the z direction of the slot portion 314S3, which is approximately a center in the x direction, which is the longitudinal direction, and disposed oppositely to a restricting surface 313f of the light guide stay 313 (see part (a) of FIG. 8), which will be described in detail below, with a gap. This opposite surface 314c is formed in a plane shape. In addition, the light guide 314 includes, below the slot portion 314S1, a positioning pin 314a, which is formed in a rod shape so as to extend below and is inserted into a long hole portion 313b (see part (b) of FIG. 8) of the light guide stay 313, which will be described in detail below.

And as shown in FIG. 6, part (a) of FIG. 9 and part (b) of FIG. 9, the light guide 314 includes a first projection 314P1 and a second projection 314P2, which extend from the first end portion 314E1 and the second end portion 314E2, respectively, so as to project in the x direction. Functions of the first projection 314P1 and the second projection 314P2 will be described in detail below.

On the other hand, the light guide stay 313 includes, as shown in part (a) of FIG. 8 and part (b) of FIG. 8, supporting portions 313SL and 313SR, which are formed in plane shapes so as to support the two light guide units 312L and 312R. In addition, in the light guide stay 313, a wall portion 313W, which stands on these supporting portions 313SL and 313SR as bottom surfaces so as to surround these supporting portions 313SL and 313SR, is formed. Incidentally, in the present description, as described above, since the light guide unit 312R is described as an example, the supporting portion 313SR will be described herein and description for the supporting portion 313SL, which has the same configuration as the supporting portion 313SR, will be omitted. That is, in the light guide stay 313, the supporting portions 313SL and 313SR are formed symmetrically in the sub scanning direction in order for the light guide unit 312L or 312R to be attached. Incidentally, in the light guide stay 313, an opening portion 313AP, which permits the reflected light from the original D to pass inside the box frame, is formed between the supporting portions 313SL and 313SR. In addition, in the light guide stay 313, a positioning hole 313c, which is a through hole for positioning the light guide stay 313 with respect to the upper portion of the box frame 307 (see FIG. 5), is formed.

The supporting portion 313SR of the light guide stay 313 includes the supporting surfaces 313a and 313a, which are constituted by two inclined surfaces formed in V shapes as viewed from the x direction. The supporting surfaces 313a and 313a constitute a first supporting surface, which is disposed at one end portion of the light guide stay 313 in the x direction, which is the longitudinal direction, and a second supporting surface, which is disposed at the other end portion on an opposite side, respectively. These supporting surfaces 313a and 313a contact the contacting surfaces 314b and 314b of the light guide 314, respectively, and support the light guide 314 while positioning the light guide 314 in the y direction. In addition, the supporting portion 313SR includes a long hole portion 313b, into which the positioning pin 314a of the light guide 314 is inserted. In addition, in the supporting portion 313SR, as shown in part (a) of FIG. 8, a positioning surface 313d as a third supporting surface, an adjusting hole 313e and the restricting surface 313f are disposed between the supporting surfaces 313a and 313a and approximately at the center in the x direction, which is the longitudinal direction. That is, by the positioning surface 313d of the light guide stay 313 being contacted by an end surface 314d as a third contacting surface of the light guide 314 upon the light guide 314 being attached to the light guide stay 313, a position in the y direction of the light guide 314 is restricted and positioned. In addition, into the adjusting hole 313e, an unshown tool is inserted, and a position in the z direction of the light guide 314 is adjusted upon the light guide 314 being attached to the light guide stay 313. In addition, the restricting surface 313f is disposed oppositely to the opposite surface 314c of the light guide 314 described above with the gap, and is configured to be contactable each other when adhesion between the light guide stay 313 and the light guide 314 is peeled off, as described in detail below.

And in the wall portion 313W of the light guide stay 313, portions, which are disposed oppositely to the first end portion 314E1 and the second end portion 314E2 of the light guide 314 in the x direction, which is the longitudinal direction, are formed as a first opposing portion 313W1 and a second opposing portion 313W2, respectively. In these first opposing portion 313W1 and the second opposing portion 313W2, as shown in FIG. 6, part (a) of FIG. 9 and part (b) of FIG. 9, a first restricting portion 313C1 and a second restricting portion 313C2 are formed so as to be recessed in the z direction crossing the x direction. That is, these first restricting portion 313C1 and the second restricting portion 313C2 are formed in concave shapes having wider widths than those of the first projection 314P1 and the second projection 314P2, respectively.

In other words, it is configured so that, upon the light guide 314 being attached to the light guide stay 313, the first projection 314P1 and the second projection 314P2 enter these first restricting portion 313C1 and the second restricting portion 313C2, respectively. And, as shown in part (b) of FIG. 9, it is configured so that, between each of these first restricting portion 313C1 and the second restricting portion 313C2 and the first projection 314P1 and the second projection 314P2, gaps dy and dy are provided in the y direction and a gap dz is provided in the z direction. That is, the first projection 314P1 and the second projection 314P2 are inserted into the first restricting portion 313C1 and the second restricting portion 313C2 with a gap, respectively. In other words, in a state in which the light guide 314 is adhered to the light guide stay 313, the first projection 314P1 does not contact the first restricting portion 313C1, and the second projection 314P2 does not contact the second restricting portion 313C2.

### [Assembly Steps of the Light Guide to the Light Guide Stay]

Next, steps upon assembling the light guide 314 to the light guide stay 313 will be described. First, the inserting portion 316Ba of the LED substrate 316 is inserted by a predetermined amount into the slot portions 314S1 through 314S5 of the light guide 314, and assemble as the light guide unit 312R or 312L (see part (a) of FIG. 7). Next, the light guide unit 312R or 312L is attached to the light guide stay 313 (see FIG. 6). At this time, as positioning in the y direction, the contacting surfaces 314b and 314b having the arc shapes, which are disposed at the both end portions of the light guide 314, are brought into contact with the supporting surfaces 313a and 313a having the V shapes, which are disposed at the both end portions of the light guide stay 313 (see part (c) of FIG. 7 and part (b) of FIG. 8), respectively. Furthermore, as positioning in the x direction, the positioning pin 314a of the light guide 314 is fitted into the long hole portion 313b of the light guide stay 313 (see part (c) of FIG. 7 and part (b) of FIG. 8). In addition, at this time, the opposite surface 314c, which is disposed approximately at the center in the longitudinal direction of the light guide 314, is disposed so as to have the gap against the restricting surface 313f, which is disposed at the corresponding position in the light guide stay 313. And as shown in part (b) of FIG. 9, the first projection 314P1 and the second projection 314P2 of the light guide 314 are disposed oppositely to the first restricting portion 313C1 and the second restricting portion 313C2 of the light guide stay 313 in a manner that the gaps dy, dy and dz are provided therebetween, respectively.

Thereafter, a UV adhesive is applied to the portions, at which the contacting surfaces 314b and 314b of the light guide 314 of the light guide unit 312R or 312L and the supporting surfaces 313a and 313a of the light guide stay 313 contact each other, and a UV adhesion is performed. Furthermore, the UV adhesion is performed by the UV adhesive being applied, in a gap at which the LED substrate 316 of the light guide unit 312R or 312L and the light guide stay 313 come close to each other, to a plurality of locations (for example, five locations) at predetermined intervals (for example, interval from 50 to 100 mm) in the x direction. By this, the light guide unit 312R or 312L (i.e., the respective light guide 314) is fixed and attached to the light guide stay 313. Incidentally, the UV adhesion is a method for adhering by curing UV light curing resin used as an adhesive by ultraviolet light, however, not limited to the UV adhesion, but other fixing methods such as an adhesion without using the UV light curing resin, crimping, thermal adhesion and screwing may also be applied.

### [Problems Due to Warpage of the Light Guide]

Here, problems caused by occurrence of warpage of the light guide 314 will be described. FIG. 10 is an explanatory view illustrating a warping direction of the light guide according to the Embodiment 1.

It is general that the light guide 314 is principally formed of resin material having high transparency such as acrylic resin and polycarbonate resin. As described above, since the light guide 314 has a complex shape with a shape which forms an optical passage which reflects the light from the incident surface 314Aa, a shape for the positioning, etc., it is general that the light guide 314 is produced by injection molding using an injection molding machine. The injection molding is a method in which resin material melted by high heat is injected to a mold with pressure, and after being cooled, taken out of the mold, and is produced as a component. The light guide 314 as a produced component contains not a small amount of variation due to tolerance in the shape thereof and may not be produced in accordance with theoretical dimensions. In the light guide 314, a case, in which the shape which reflects the light incident from the incident surface 314Aa to the emergent surface 314Ab side and/or a minute shape provided on the emergent surface 314Ab is not reproduced in details, etc., may occur. That is, it is said that the light guide 314 has good transferability when the light guide 314 is in a state in which the light guide 314 is produced in accordance with the theoretical dimensions and shape dimensions thereof is accurately reproduced in the details, and has poor transferability when the light guide 314 contains a lot of variation. In general, upon aiming the good transferability in the injection molding, for example, the transferability tends to become good by setting temperature of the mold and/or of resin higher, and/or by setting the pressure upon injecting the material to the mold stronger to set a speed higher.

In addition, in the light guide 314, which is a component extending in the longitudinal direction, the warpage, in which the light guide 314 is partially or entirely bent in the y direction and/or in the z direction, may occur. That is, in a case of an elongated shape in one direction as the light guide 314, even a small amount of the warpage results in a large fluctuation amount depending on locations, and effect to product quality becomes significant. Causes for the occurrence of the warpage include, for example, residual stress because of facts that timings, at which heat stored during the molding of the component is cooled, are uneven and that material density within the component is uneven. To reduce the warpage, i.e., to reduce the residual stress, in general, by designing a shape so that an entire component is cooled evenly and/or by increasing the pressure upon injecting the material into the mold, it tends to become good.

However, though depending on the shape of the light guide 314 as a component, in general, relationship between a fact that the transferability is good and a fact that the warpage is small tends to conflict. For a component which forms the optical passage such as the light guide 314, it is required to make the transferability of the minute shape better, make the warpage as a component small, and set a posture of the light guide 314 upon being attached to the light guide stay 313 and a position of the emergent surface 314Ab, etc., in accordance with designed values. Therefore, in the light guide 314 attached to the light guide stay 313, it is desired to satisfy the conflicting requirements.

In the light guide 314 according to the present Embodiment, the warpage in a direction as shown by an arrow W in FIG. 10, for example, may occur. In molding of the present light guide 314, the light guide 314 is molded under a condition in which the transferability is prioritized, and a warping amount is allowed to some extent. Therefore, upon attaching the light guide unit 312L or 312R to the light guide stay 313, while correcting the warpage of the light guide 314, the light guide 314 is adhered and attached.

At this time, the positioning between the light guide 314 and the light guide stay 313 in the y direction is positioned by the contacting surfaces 314b and 314b of the light guide 314 and the supporting surfaces 313a and 313a of the light guide stay 313 contacting each other, respectively. In addition, the opposite surface 314c, which is disposed approximately at the center in the longitudinal direction of the light guide 314, and the restricting surface 313f, which is disposed approximately at the center in the longitudinal direction of the light guide stay 313, are disposed with a gap therebetween in design. And this opposite surface 314c and the restricting surface 313f contact each other in a case in which the warpage occurs in the light guide 314, and suppress the warpage at a central part of the light guide 314 to a predetermined amount, in other words, it is configured to be capable of achieving an attached state in which the warping shape of the light guide 314 is corrected. Incidentally, in an initial state in which the light guide 314 and the light guide stay 313 are attached to each other, the first projection 314 P1 and the second projection 314P2 and the first restricting portion 313C1 and the second restricting portion 313C2 described above have the gaps dy, dy and dz (see part (b) of FIG. 9).

As a use environment of a user of the image forming apparatus 100, on which the image reading apparatus 101 according to the present Embodiment is mounted, for example, the image forming apparatus 100 may be used in a place with high temperature and high humidity. In addition, in a case in which the image reading apparatus 101 is transported from a country in which the image reading apparatus 101 is produced to a country in which the image reading apparatus 101 is used, etc., marine transportation thereof by ship may be performed, for example, and depending on a route taken by the ship, the image reading apparatus 101 may be exposed to a high temperature and high humidity environment, which is even harsher than the use environment of the user. When the image reading apparatus 101 is exposed to such a high temperature environment, the light guide 314 may be deformed by the residual stress, which is generated during the molding and/or the attachment of the light guide 314, which is a resin component, being gradually released. Then, the UV adhesive portions which adheres the light guide 314 and the LED substrate 316 to the light guide stay 313 may be peeled off due to the deformation of the light guide 314. If the adhesion is peeled off in this manner, since the position and the posture of the light guide 314 with respect to the light guide stay 313 change, performance in accordance with the designed values as the image reading apparatus 101 may not be satisfied, and quality of the read image may deteriorate. Therefore, in the present Embodiment, as described below, a purpose is to suppress the deforming amount of the light guide 314 below a certain amount even in the case in which the adhesion between the light guide stay 313 and the light guide 314 is peeled off due to the deformation caused by the release of the residual stress in the light guide 314.

### [Functions of the First Projection and the Second Projection and the First Restricting Portion and the Second Restricting Portion]

Next, functions of the first projection 314P1 and the second projection 314P2 of the light guide 314 and the first restricting portion 313C1 and the second restricting portion 313C2 of the light guide stay 313 described above will be described. As described above, in the light guide 314 of the light guide units 312L and 312R, in the case in which a part of the adhesion is peeled off, the deformation such as the warpage may be generated. Incidentally, as to the adhesion between the light guide stay 313 and the light guide unit 312R or 312L, a part to which stress is concentrated due to the deformation may be peeled off, however, it is unlikely for all of the locations to be peeled off, that is, there is almost no possibility for the light guide unit 312R or 312L to fall off of the light guide stay 313.

In the case in which a part of the adhesion is peeled off in this manner, though the gaps dy, dy and dz are formed between the first projection 314P1 and the second projection 314P2 and the first restricting portion 313C1 and the second restricting portion 313C2 as described above, the projections are moved in a deformed direction and are brought into contact the restricting portions. Then, the projections are restricted at the contacting positions in this manner. In addition, at this moment, in a vicinity of the center in the x direction, the opposite surface 314c of the light guide 314 may contact the restricting surface 313f of the light guide stay 313. In this case, the warpage at the central part of the light guide 314 is also restricted at that position. By this, the deforming amount of the light guide 314 is suppressed below the certain amount, i.e., it becomes possible to reduce positional misalignment between the light guide 314 and the light guide stay 313. Thus, it becomes possible to reduce deterioration in quality of the read image in the image reading apparatus 101.

### Embodiment 2

Next, an Embodiment 2, in which a part of the Embodiment 1 is changed, will be described using FIG. 11. Part (a) of FIG. 11 is a top view illustrating an end portion of an illuminating unit according to the Embodiment 2. Part (b) of FIG. 11 is a side view illustrating the illuminating unit according to the Embodiment 2. Incidentally, in description of the present Embodiment 2, the same reference numerals are used for parts which are the same as the Embodiment 1, and description thereof will be omitted.

In a front surface reading portion 301 in an image reading apparatus 101 according to the present Embodiment 2, a first projection 314P1 and a second projection 314P2 of a light guide 314 and a first restricting portion 313C1 and a second restricting portion 313C2 of a light guide stay 313 are adhered to each other. In detail, as in the Embodiment 1 described above, a light guide unit 312L or 312R is adhered and fixed to the light guide stay 313. In this state, as shown in part (a) of FIG. 11 and part (b) of FIG. 11, a first adhesive portion 320 formed by applying the UV adhesive, etc. between the first projection 314P1 and the second projection 314P2 and the first restricting portion 313C1 and the second restricting portion 313C2 is provided. In other words, the first adhesive portion 320, which fills the gaps dy, dy and dz shown in part (b) of FIG. 9 with the adhesive, is formed. Incidentally, although illustration in the figure is omitted, similarly, a second adhesive portion is also formed between the second projection 314P2 of the light guide 314 and the second restricting portion 313C2 of the light guide stay 313.

That is, as described above, in the light guide 314 of the light guide unit 312L or 312R, in the case in which a part of the adhesion is peeled off, the deformation such as the warpage may occur. However, the first projection 314P1 and the second projection 314P2 and the first restricting portion 313C1 and the second restricting portion 313C2 are positioned by the first adhesive portion 320 and the second adhesive portion, and are restricted at those positions. By this, a deforming amount of the light guide 314 is suppressed below a certain amount, i.e., it becomes possible to reduce positional misalignment between the light guide 314 and the light guide stay 313. Thus, it becomes possible to reduce deterioration in quality of the read image in the image reading apparatus 101.

Incidentally, for example, it is unlikely for the first adhesive portion 320 and/or the second adhesive portion to be peeled off from the first projection 314P1 and the second projection 314P2, however, it may be likely to be peeled off of the first restricting portion 313C1 and the second restricting portion 313C2. However, since the first adhesive portion 320 is cured, the positioning between the first projection 314P1 and the second projection 314P2 and the first restricting portion 313C1 and the second restricting portion 313C2, respectively, is maintained.

In addition, if it is configured to have a shape, in which the first projection 314P1 and the first restricting portion 313C1 are fitted without a gap, and a shape, in which the second projection 314P2 and the second restricting portion 313C2 are fitted without a gap, assembly performance may become not good due to component tolerances. Therefore, also in the case of adhering with the first adhesive portion 320 and the second adhesive portion as in the present Embodiment 2, it is more preferable to provide the gaps.

### Embodiment 3

Next, an Embodiment 3, in which a part of the Embodiment 1 is changed, will be described using FIG. 12. FIG. 12 is a top view illustrating an end portion of an illuminating unit according to the Embodiment 3. Incidentally, in description of the present Embodiment 3, the same reference numerals are used for parts which are the same as the Embodiment 1, and description thereof will be omitted.

In the Embodiment 1 described above, the first projection 314P1 and the second projection 314P2 having shaft shapes are formed in the light guide 314, and the first restricting portion 313C1 and the second restricting portion 313C2 having groove shapes are formed in the light guide stay 313. In the present Embodiment 3, opposite to these, as shown in FIG. 12, a first projection 313P1 having a shaft shape is formed in a light guide stay 313, and a first restricting portion 314C1 having a groove shape is formed in a light guide 314.

In detail, in a first opposing portion 313W1 in a wall portion 313W of the light guide stay 313, the first projection 313P1 having the shaft shape is formed so as to project toward the light guide 314 in the x direction. On the other hand, in a first end portion 314E1 of the light guide 314, the first restricting portion 314C1 having the groove shape having a wider width than that of the first projection 313P1 is formed so as to be recessed in the z direction crossing the x direction. Thus, while a gap is formed therebetween, the first projection 314P1 and the first restricting portion 314C1 are disposed oppositely to each other. Incidentally, although illustration in the figure is omitted, similarly, the second projection is also formed in a second opposing portion 313W2 of the light guide stay 313, and a second restricting portion is formed also in a second end portion 314E2 of the light guide 314.

Also in the Embodiment 3 configured in this manner, in the case in which a part of the adhesion between the light guide stay 313 and the light guide units 312L or 312R is peeled off, the light guide 314 may be deformed. In this case, the first restricting portion 314C1 is moved in a deformed direction and contacts the first projection 313P1, and is restricted at the contacting position. Incidentally, also between the second projection and the second restricting portion, of which illustration in the figure is omitted, in the case in which the light guide 314 is deformed, the second restricting portion 314C2 contacts in the same manner and a position thereof is restricted. By this, a deforming amount of the light guide 314 is suppressed below a certain amount, i.e., it becomes possible to reduce positional misalignment between the light guide 314 and the light guide stay 313. Thus, it becomes possible to reduce deterioration in quality of the read image in the image reading apparatus 101.

### Possibility for Other Embodiments

Incidentally, in the Embodiment 1 through the Embodiment 3 described above, the first projection 314P1, 313P1 and the second projection 314P2, 313P2 are described as being the shaft shapes. However, it is not limited thereto, but may be any shape such as a cylindrical shape, a prismatic shape, a conical shape and a plate shape as long as the projection is contactable or can be adhered to the first restricting portion or to the second restricting portion.

In addition, in the Embodiment 1 through the Embodiment 3, the first restricting portion 313C1, 314C1 and the second restricting portion 313C2, 314C2 are described as being the groove shapes. However, it is not limited thereto, but may be any shape such as a long hole shape, a slit shape and a through hole shape as long as the restricting portion is contactable or can be adhered to the first projection or the second projection.

In addition, in the Embodiment 1 and the Embodiment 2, the configurations in which the first projection 314P1 and the second projection 314P2 are formed in the light guide 314, and the first restricting portion 313C1 and the second restricting portion 313C2 are formed in the light guide stay 313 are described. Furthermore, in the Embodiment 3, the configuration in which the first projection 313P1 and the second projection are formed in the light guide stay 313 and the first restricting portion 314C1 and the second restricting portion are formed in the light guide 314 is described. In other words, the configurations in which two projection or two restricting portions are formed in the light guide 314 and two restricting portions or two projections are formed in the light guide stay 313 are described. However, it is not limited thereto, but one projection and one restricting portion may be formed in the light guide 314, and one restricting portion and one projection may be formed in the light guide stay 313. In short, it may be configured that one of the first end portion 314E1 and the first opposing portion 313W1 includes a first projection projecting in the longitudinal direction, and the other of the first end portion 314E1 and the first opposing portion 313W1 includes a first restricting portion, which is disposed on the supporting portion side oppositely to the first projection. In addition, it may be configured that one of the second end portion 314E2 and the second opposing portion 313W2 include a second projection projecting in the longitudinal direction, and the other of the second end portion 314E2 and the second opposing portion 313W2 includes a second restricting portion, which is disposed on the supporting portion side oppositely to the second projection.

In addition, in the Embodiment 1 through the Embodiment 3, the configurations in which the gaps are provided between the first projection 314P1, 313P1 and the second projection 314P2, 313P2 and the first restricting portion 313C1, 314C1 and the second restricting portion 313C2, 314C2 are described. However, without providing the gaps therebetween, a type such as press-fitting may be employed. In short, the position of the light guide 314, whose adhesion has been peeled off, has only to be restricted and positioned with respect to the light guide stay 313.

In addition, in the Embodiment 1 through the Embodiment 3, the description has been made by using the front surface reading portion 301, in which the light guide units 312L and 312R are adhered to the light guide stays 313, as an example, however, the back surface reading portion 205 may also be configured in the same manner.

In addition, in the Embodiment 1 through the Embodiment 3, the configurations in which the image reading apparatus 101 is provided to the image forming apparatus 100 are described, however, it is not limited thereto, but the image reading apparatus may be any image reading apparatus as long as the image reading apparatus is provided with the image reading portion which reads the image such as a scanner apparatus and an inspection apparatus.

According to the present invention, it becomes possible to reduce the positional misalignment between the light guide member and the supporting member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-078953 filed on May 14, 2024, which is hereby incorporated by reference herein in its entirety.

What is claimed is:

1. An image reading apparatus comprising:
a light guide unit provided with a substrate including a plurality of light sources arranged side by side in a longitudinal direction and a light guide member configured to guide a light emitted from the light sources to an original;
a reading portion configured to read an image of the original which reflects the light irradiated from the light sources through the light guide member; and
a supporting member including a supporting portion configured to support the light guide unit by the light guide unit being adhered to the supporting member, a first opposing portion opposing a first end portion of the light guide member in the longitudinal direction, and a second opposing portion opposing a second end portion, opposite to the first end portion, of the light guide member in the longitudinal direction,
wherein one of the first end portion and the first opposing portion includes a first projection projecting in the longitudinal direction,
wherein the other of the first end portion and the first opposing portion includes a first concave portion which has a concave shape having a wider width than that of the first projection and into which the first projection is inserted with a gap,
wherein one of the second end portion and the second opposing portion includes a second projection projecting in the longitudinal direction, and
wherein the other of the second end portion and the second opposing portion includes a second concave portion which has a concave shape having a wider width than that of the second projection and into which the second projection is inserted with a gap.

2. The image reading apparatus according to claim 1, wherein at least one of the first projection and the first concave portion, and the second projection and the second concave portion become contactable each other when adhesion between the light guide member and the supporting portion of the supporting member is peeled off.

3. The image reading apparatus according to claim 1, wherein the first projection is formed on the first end portion,
wherein the first concave portion is formed on the first opposing portion,
wherein the second projection is formed on the second end portion, and
wherein the second concave portion is formed on the second opposing portion.

4. The image reading apparatus according to claim 1, wherein the first projection is formed on the first opposing portion,
wherein the first concave portion is formed on the first end portion,
wherein the second projection is formed on the second opposing portion, and
wherein the second concave portion is formed on the second end portion.

5. The image reading apparatus according to claim 1, further comprising:
a first adhesive portion configured to adhere the first projection and the first concave portion; and
a second adhesive portion configured to adhere the second projection and the second concave portion.

6. The image reading apparatus according to claim 1, wherein the supporting portion includes a first supporting surface disposed at one end portion in the longitudinal direction, a second supporting surface disposed at the other end portion opposite to the one end portion in the longitudinal direction, and a third supporting surface disposed between the first supporting surface and the second supporting surface in the longitudinal direction, and
wherein in a state of being adhered to the supporting portion, the light guide unit includes a first contacting surface contacted and supported by the first supporting surface, a second contacting surface contacted and supported by the second supporting surface and a third contacting surface contacted and supported by the third supporting surface.

7. An image forming apparatus comprising:
an image forming portion configured to form an image on a sheet;
a light guide unit provided with a substrate including a plurality of light sources arranged side by side in a longitudinal direction and a light guide member configured to guide a light emitted from the light sources to an original;
a reading portion configured to read an image of the original which reflects the light irradiated from the light sources through the light guide member; and
a supporting member including a supporting portion configured to support the light guide unit by the light guide unit being adhered to the supporting member, a first opposing portion opposing a first end portion of the light guide member in the longitudinal direction, and a second opposing portion opposing a second end portion, opposite to the first end portion, of the light guide member in the longitudinal direction,
wherein one of the first end portion and the first opposing portion includes a first projection projecting in the longitudinal direction,
wherein the other of the first end portion and the first opposing portion includes a first concave portion which has a concave shape having a wider width than that of the first projection and into which the first projection is inserted with a gap,
wherein one of the second end portion and the second opposing portion includes a second projection projecting to the longitudinal direction, and
wherein the other of the second end portion and the second opposing portion includes a second concave portion which has a concave shape having a wider width than that of the second projection and into which the second projection is inserted with a gap.
